(19) United States
(12) Patent Application Publication
(10) Pub. No.: US 2024/0260805 A1
(43) Pub. Date: Aug. 8, 2024

(54) REGULAR HOUSEHOLD CLEANING

(71) Applicant: BSH Hausgeräte GmbH, München (DE)

(72) Inventors: Maximilian Fremerey, Saal an der Saale (DE); Florian Schmitt, Bad Neustadt (DE)

(21) Appl. No.: 18/570,205

(22) PCT Filed: May 24, 2022
(86) PCT No.: PCT/EP2022/064036

§ 371 Date: Dec. 14, 2023

(30) Foreign Application Priority Data
Jun. 16, 2021 (DE) 10 2021 206 121.4

(51) Int. Cl. A47L 11/40

(52) U.S. Cl. CPC A47L 11/4011; A47L 11/4008; A47L 2201/06

(57) ABSTRACT

A robot is configured to move around a household and to perform a cleaning function. The household is divided into several areas, with cleaning frequencies assigned to the respective areas. A method for controlling the robot includes controlling the cleaning of each area in dependence on the cleaning frequency assigned to it.

The invention relates to the regular cleaning of a household. In particular, the invention relates to the cleaning of the household by means of an autonomous household robot.

A household robot is configured so as to move autonomously in a household and to clean the floor. For the orientation of the household robot, an environment map can be created, which in particular reflects a floor plan of the household. Sections of the household can be marked, for example, for intensive cleaning or for the exception of a cleaning run. The household robot is then usually activated to clean the household on the basis of the environment map, for example, always on weekdays. If necessary, an additional cleaning run can be triggered manually.

This generally does not take into account that different sections of a household are used or soiled with different frequency or intensity. A first area, which is rarely used and is regularly only slightly soiled, can therefore be cleaned too often or too intensively, while a second area, which is less frequently but is more intensely soiled, can be cleaned to an insufficiently intensive extent.

One object of the present invention is therefore to specify an improved technique for the regular cleaning of a household. The invention achieves this object by means of the subjects of the independent claims. Subordinate claims reflect preferred embodiments.

According to a first aspect of the present invention, a robot is configured so as to move in a household and to perform a cleaning function. The household is divided into multiple areas, wherein cleaning frequencies are allocated to the areas. A method for controlling the robot comprises controlling a cleaning of each area in dependence upon the cleaning frequency that is allocated to the area.

In accordance with the invention, it can be individually determined by a user for different areas how often the area is to be cleaned in each case. The individual areas can be kept clean in an improved manner without requiring a sensor for determining different degrees of soiling. Areas that are subject to greater or more regular soiling can be cleaned more frequently than areas that are rarely soiled. The areas are in each case contiguous and preferably the entire household can be divided disjointly into areas. By specifying different cleaning frequencies, the areas can be cleaned individually on a regular basis. In particular, an improved time-based cleaning can be realized, wherein different areas are repeatedly cleaned at different intervals.

It is preferred that a cleaning frequency comprises a multiple of a predetermined time interval. The multiple can in particular be an integer. The predetermined time interval can be specified for example in minutes or hours and is either fixedly predetermined or selectable by a user. Exemplary time intervals include six hours, twelve hours, and twenty-four hours. Shorter or longer time intervals are also conceivable. Due to the support of a common time interval, cleaning runs of the areas can be carried out in a grid in which the cleaning of areas to be cleaned with different frequencies is combined. A person in the household can be disturbed to a lesser extent, while at the same time the household can be kept clean automatically in an improved manner.

The household can comprise multiple rooms, and an area can in particular relate to one room. In one embodiment, a room of the household is identified and determined as an area. This process can be carried out in particular as part of a mapping of the household by the robot. The mapping can be carried out in a separate mapping run or during the cleaning of the household, for example, on the basis of a slam algorithm (simultaneous localization and mapping). The room can thus be identified, for example, on the basis of walls and a passage or a door.

In this way, a room that is divided, for example, by means of a set of shelves can also be identified as one room. A user can readjust an identified area so that the area can better correspond to a room or a corresponding section of the household. Alternatively, the user can also create an area manually, wherein a room can be divided into multiple areas. An area that is determined can be subdivided and areas that are formed can be fused together if they are adjacent to one another. It is preferable for the areas to be disjoint from one another, but in one embodiment, it is also possible for two areas to overlap one another.

In a further preferred embodiment, a type of room is identified, wherein a cleaning frequency that is allocated to the type of room can be proposed. The type of room can in particular reflect its usual or preferred use and comprise, for example, a living room, a bedroom, a kitchen, a bathroom, a children's room, a nursery, a study, a sports room, a music room or a storage room. The type of a room can be identified from a section or a location of the room with respect to adjacent rooms or with respect to the household. The type of room can also be determined on the basis of furniture that is identified in the room, which can comprise, for example, a dining table, a work table, a bed, an instrument or a sports device. For an identified room, a designation can be proposed, which can preferably be understandable and descriptive for an operator. The household can be completely divided into areas and a unique name can be allocated to each area. For this purpose, the person can adapt, accept or replace a proposal with an individual input.

In a further preferred embodiment, a cleaning intensity is recorded for each area, wherein it is possible to control the cleaning of an area with the allocated cleaning intensity. The type of room can also be allocated a cleaning intensity that can be proposed for adoption. A user can accept the proposed cleaning intensity or replace it with an individual specification. It has been shown that in most cases a distinction of about three different cleaning intensities is sufficient. In this case, a cleaning intensity of zero is preferably not provided.

The cleaning intensity can indicate how a cleaning facility of the robot is operated during the cleaning. For example, the cleaning facility can comprise a suction unit and the cleaning intensity can indicate how strongly a fan of the suction unit is controlled. If the cleaning process that is performed by the robot comprises a mechanical floor processing, for example by moving a damp cloth over the floor, a contact pressure or a movement speed can be controlled, for example. In a further embodiment, a travel speed of the robot can be reduced in order to increase the intensity of a cleaning. In this way, both a cleaning frequency and a cleaning intensity can be individually determined for an area. An interaction of these two variables can offer sufficient flexibility to keep the area clean with relatively little outlay of energy or time.

In a further embodiment, an opposing change in the cleaning frequency and the cleaning intensity can be offered. For example, a user can decide to carry out a cleaning more often and less intensively than initially specified. Conversely, they can also opt for a rarer and more intensive cleaning.

In yet another preferred embodiment of the invention, areas to be cleaned are determined, which are to be cleaned at the same time in relation to their cleaning frequencies. At the same time, areas to be cleaned can nominally have the same start time due to the cleaning frequency that is allocated to them and are preferably cleaned within a contiguous cleaning run. Although the areas are actually cleaned by the robot one after the other, their cleaning is usually allocated to the same time interval. If the time interval is, for example, three hours and the first area is to be cleaned every six hours and the second every nine hours, a simultaneous cleaning of both areas every eight and ten hours can be planned in this sense.

If the areas that are determined cannot be processed contiguously, in particular because an energy storage device that is carried by the robot does not have sufficient capacity, the cleaning process of the areas can be interrupted by a charging process.

The cleaning of the areas that are determined can be interrupted by charging the energy storage device of the robot in such a manner that, as far as possible, each of the specific areas is either completely cleaned or completely not cleaned during the charging. In other words, charging can preferably be controlled whenever the robot has finished cleaning a first area and the cleaning of a subsequent second area has not yet begun. In this way, it can be prevented that a partially cleaned area is newly contaminated, for example, on account of use by household members.

If a constellation arises in which the leaving behind of a partially cleaned area is not to be avoided, this area can also be divided into two subareas, which are then each completely cleaned or completely not cleaned, while the robot recharges its energy storage device.

For the areas that are determined, an amount of energy that is required for their cleaning can be determined in each case. The charging can be planned in relation to the determined amounts of energy and a state of charge of an energy storage device of the robot. In this way, it can be predicted with good certainty which areas can be cleaned in a common cleaning run and between which processes a charging process is to be inserted.

An order of processing of the individual areas can be adapted in such a manner that the energy storage device is utilized in an improved manner. The planning can be carried out prior to the start of a cleaning run, during the cleaning run or during a charging process. It is preferable for a predetermined safety reserve to be planned in order to prevent the robot from having to leave an area partially cleaned or even stopping with an empty energy storage device.

To determine the required amount of energy, an energy consumption of a cleaning facility of the robot can be considered. In addition, an energy that is required for the movement of the robot can be taken into account. In one embodiment, both amounts of energy can be expressed per distance traveled by the robot. A combined energy consumption per traveling distance during the cleaning can also be specified. This amount of energy can be dependent on a driving speed and/or a cleaning intensity. For the area whose size is known, an amount of energy that is to be used can be easily determined.

In a further preferred embodiment, areas to which the same cleaning intensities are allocated are cleaned as contiguously as possible. In other words, the cleaning of areas having the same cleaning intensities is preferably not interrupted by charging. An acoustic load from the cleaning process can be reduced as a result.

Charging is preferably planned in such a manner that a predetermined amount of energy is still present in the energy storage device at the beginning of a charging process. This amount of energy can be used as safety measure to ensure a return of the robot to a charging station. This safety measure can be increased with increasing age of the robot or the energy storage device in order to map an aging effect. In this way, it can be prevented that the energy storage device is exhausted at an unfavorable time.

According to a further aspect of the present invention, an apparatus is configured so as to control a robot in order to move the robot in a household and to perform a cleaning function. The household is divided into multiple areas and cleaning frequencies are allocated to the areas. The apparatus is preferably configured so as to control a cleaning of each area in dependence upon the cleaning frequency that is allocated to the area.

The apparatus can comprise a processing facility that is configured so as to implement in whole or in part a method that is described herein. For this purpose, the processing facility preferably comprises a programmable microcomputer or microcontroller and the method is more preferably in the form of a computer program product having program code means. In a further embodiment, the computer program product can also be stored on a computer-readable data carrier. Features or advantages of the method can be transferred to the apparatus and vice versa.

According to yet another aspect of the present invention, a household robot comprises an apparatus for controlling, which is described herein.

The invention will now be described in more detail with reference to the accompanying figures in which:

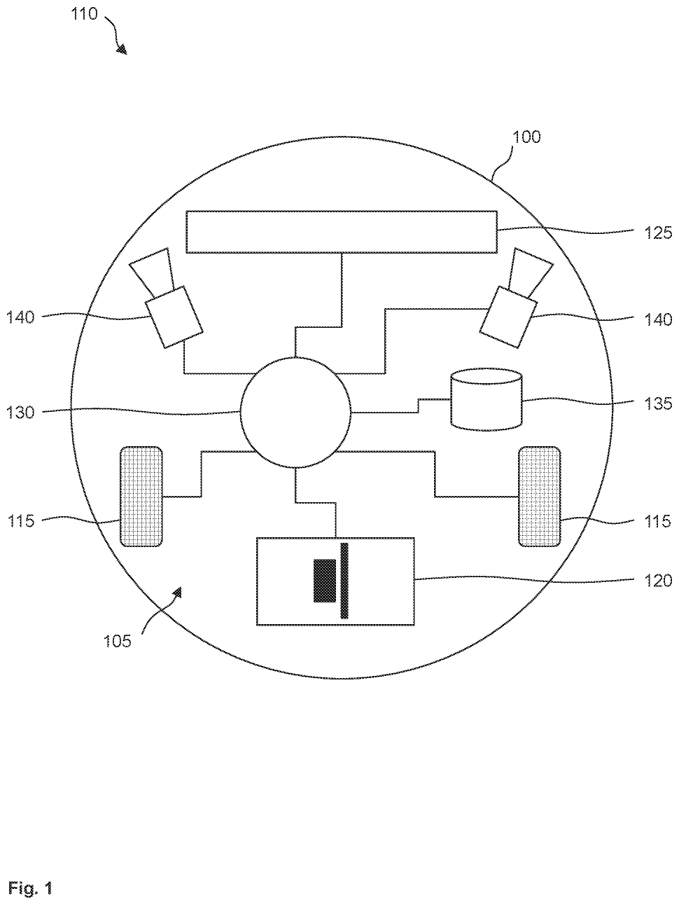

FIG. 1 shows a household robot having a control apparatus;

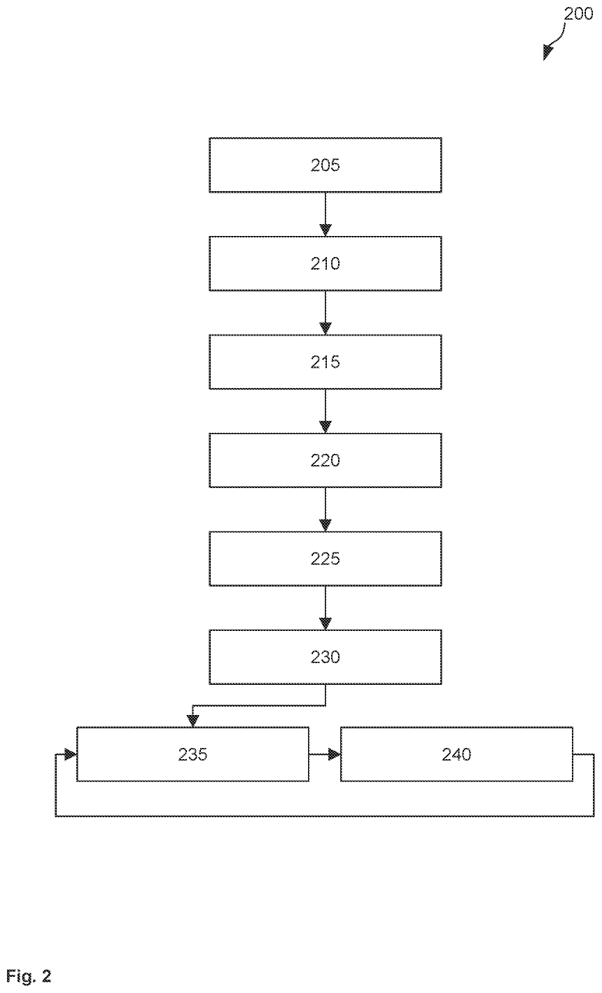

FIG. 2 shows a flowchart of a method for controlling a household robot; and

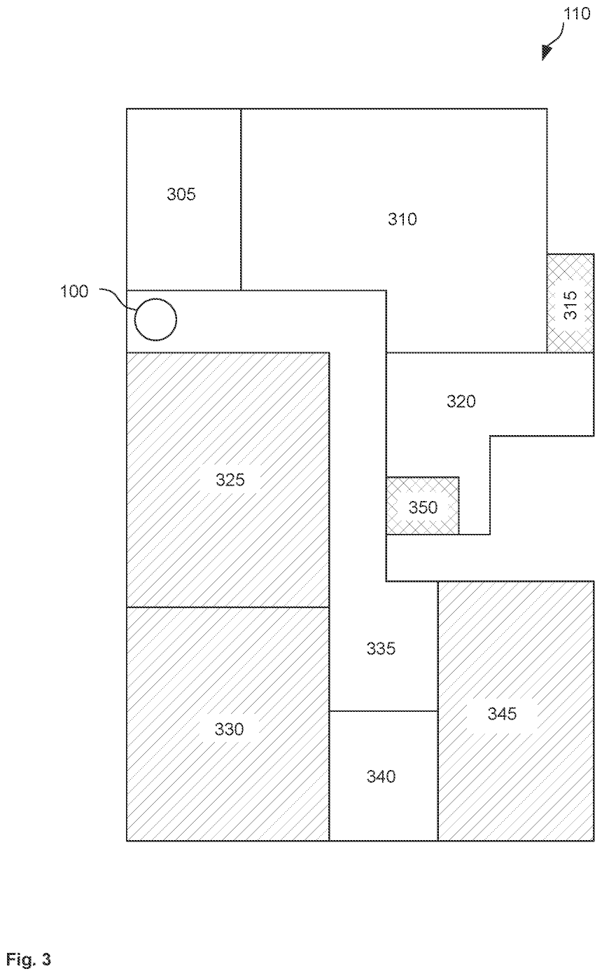

FIG. 3 shows a floor plan of an exemplary household.

FIG. 1 illustrates a household robot 100 having a control apparatus 105. The household robot 100 is configured so as to move autonomously in a household 110 and in this case to perform a predetermined cleaning activity. Purely as an example, it is assumed in the present case that the cleaning function comprises vacuuming.

The robot 100 usually comprises a drive 115, an energy storage device 120, a cleaning facility 125 and a processing facility 130. In the present case, the drive 115 is realized by two individually controllable wheels. An electric motor can be attached to each wheel. The electric motors can be fed from the energy storage device 120, which is preferably configured as a rechargeable electrical energy storage device 120. In the present case, the cleaning facility 125 comprises a suction unit, which usually comprises a suction mouth, a dust filter and a fan. The fan can also be operated by means of energy from the energy storage device 120. The processing facility 130 preferably controls the interaction between a movement of the robot 100 by means of the drive 115 and the execution of a cleaning function by means of the cleaning facility 125.

For the planned movement of the robot 100 within the household 110, a data storage device 135 is preferably provided in which an environment map of the household can be stored. One or more sensors 140 are provided for scanning an environment of the robot 100. A position of the robot 100 in the household 110 can be determined on the basis of scans of the sensors 140. At the same time, the scans can be used as a basis for creating or updating the environment map in the data storage device 135.

Usually, the control apparatus 105 is mounted on board the household robot 100. In a further embodiment, a part of the control apparatus 105 can also be provided externally, for example the data storage device 135 and/or the processing facility 130. Information between the control apparatus 105 and the household robot 100 can then be transmitted by means of a preferably wireless interface.

It is proposed that the robot 100 is configured so as to clean different areas of the household 110 with respectively allocated cleaning frequencies and/or cleaning intensities. The determinations that are required for this can be carried out by means of the processing facility 130 or by means of another control apparatus, the results of which are then transmitted to the control apparatus 105.

FIG. 2 illustrates a flowchart of a method 200 for controlling a household robot 100. In a step 205, an environment map of the household 110 can be created. The environment map can be created by the robot 100 while it is traveling through the household 110, or can come from an external source. For example, a user can contribute information for the provision of the environment map.

In a step 210, areas can be determined within the household 110. In other words, the household 110 can be divided or segmented into areas. In this case, an area can in particular correspond to a room of the household 110. A type of room can be determined automatically, for example, on the basis of furniture that was found in the room. At this point, a name can be allocated to an area. For this purpose, a proposal can be made on the basis of the determined type of room, which a user can accept or change.

In a step 215, cleaning frequencies can be recorded for the areas and allocated to the areas. Preferably, each area is allocated a cleaning frequency individually. A proposal for a possible cleaning frequency can be provided on the basis of a determined type of room. A user can accept this proposal or specify a different value.

In a step 220, cleaning frequencies can be recorded for the areas and allocated to the individual areas. A proposal for a cleaning intensity can be provided on the basis of a determined type of room. A user can accept such a proposal or perform a manual input. Finally, the entered or determined information can be verified and, if necessary, modified. For example, cleaning frequencies or cleaning intensities of different areas can be better coordinated with one another.

In a step 225, a cleaning trip can be planned. Cleaning trips usually begin with integer multiples of a predetermined time grid, which can be, for example, six hours. For example, cleaning trips can be started at six o'clock, twelve o'clock, six pm and midnight. An area that is to be cleaned every twelve hours then has a cleaning frequency of two and another area that is to be cleaned every eighteen hours has a cleaning frequency of three.

For a given point in time, usually a next integer time interval, it is possible to determine the areas that are to be cleaned at this point in time. Subsequently, it is possible to determine an amount of energy that is required for the cleaning of each of the areas that are determined. If a sum of the determined amounts of energy exceeds an amount of energy that is received in the energy storage device 120, the cleaning trip can be subdivided in a step 230 one or more times. Between the individual cleaning trips, a charging of the energy storage device 120 can be planned.

Each cleaning trip comprises at least one area that is completely cleaned in the cleaning trip. Only partial cleaning of an area during a cleaning trip is further preferably avoided. An allocation of areas to cleaning trips can be carried out in such a manner that the amount of energy that is available in the energy storage device 120 is utilized as effectively as possible. A predetermined reserve that is to remain in the energy storage device 120 can be taken into account in this determination. In addition, the areas can be allocated to cleaning trips in such a manner that a cleaning trip has as few as possible different cleaning intensities. Areas having the same cleaning intensities are preferably cleaned one after the other.

In a step 235, a cleaning trip can be controlled via the allocated areas. If all areas are cleaned, a charging of the energy storage device 120 can be controlled in a step 240. For this purpose, the household robot 100 can, in particular, travel to a predetermined charging station, where optionally collected dirt can also be disposed of.

If it is determined in step 235 that an area that is included in the current cleaning trip and has not yet been cleaned can no longer be completely cleaned on account of a development of the amount of energy that is stored in the energy storage device 120, the charging can take place prior to the start of the cleaning of this area, and remaining areas that are still to be cleaned can be redistributed to cleaning trips.

If a cascade-like displacement of cleaning of other areas is required on account of the displacement of the cleaning of one area, an indication can be provided that the selected areas and cleaning frequencies cannot be realized by means of the household robot 100 and the selected time interval.

FIG. 3 illustrates an exemplary household 110 in the form of a floor plan. The household 110 comprises a number of areas 305-350, each comprising a room.

The following table gives an exemplary allocation of names, types, frequencies and cleaning intensities to the areas 305-350:

| Area | Name | Type | Frequency | Intensity |
|---|---|---|---|---|
| 305 | (Walk-in) Closet | Storage | 1 | 1 |
| 310 | Parents | Bedroom | 2 | 2 |
| 315 | WC | Wet room | 2 | 2 |
| 320 | Bathroom | Wet room | 2 | 2 |
| 325 | Child 1 | Bedroom | 3 | 3 |
| 330 | Child 2 | Bedroom | 3 | 3 |
| 335 | Hallway | Corridor | 3 | 2 |
| 340 | Archive | Storage | 1 | 1 |
| 345 | Office | Study | 2 | 1 |
| 350 | Shower | Wet room | 2 | 2 |

In the selected example, rooms 325, 330 and 345 are to be cleaned simultaneously at the time in question, in other words in the same cleaning run. However, since the rooms 325, 330, and 345 are relatively large, only two of them can be cleaned in one contiguous cleaning run before the energy storage device 120 of the household robot 100 needs to be recharged.

The cleaning intensities of the rooms 325 and 330 are the same, only the cleaning intensity of the room 345 deviates therefrom, so that the cleaning run is divided and the rooms 325 and 330 are cleaned before the robot 100 recharges the energy storage device 120. The cleaning of room 345 takes place only afterwards and can be placed in a common cleaning run with the cleaning of rooms 315 and 350 in order to avoid a delay in the cleaning of rooms 315 and 350 on account of their cleaning frequencies. Since the cleaning intensity of the room 345 is different from the cleaning intensities of the rooms 315 and 350, the rooms 315 and 350 are preferably cleaned contiguously and the room 345 is cleaned either before or after the rooms 315 and 350.

### REFERENCE CHARACTERS

100 Robot
105 Control apparatus
110 Household
115 Drive
120 Energy storage device
125 Cleaning facility
130 Processing facility
135 Data storage device
140 Sensor
200 Method
205 Create environment map
210 Determine areas
215 Record cleaning frequencies
220 Record cleaning intensities
225 Plan cleaning trip
230 Subdivide cleaning trip
235 Control cleaning trip
240 Control charging
305-350 Area/Room (cf. table)

1-12. (canceled)

13. A method of controlling a robot that is configured to move in a household and to perform a cleaning function, the method comprising:
dividing the household into multiple areas;
allocating respective cleaning frequencies to the areas; and
controlling a cleaning of each area with the robot in dependence upon the cleaning frequency that is allocated to the respective area.

14. The method according to claim 13, wherein a cleaning frequency comprises a multiple of a predetermined time interval.

15. The method according to claim 13, which comprises identifying a room of the household and defining the room as an area.

16. The method according to claim 15, which comprises identifying a type of the room and setting the cleaning frequency according to the type of the room.

17. The method according to claim 13, which comprises recording a cleaning intensity for each area and controlling the cleaning of each area using the allocated cleaning intensity.

18. The method according to claim 13, which comprises:
determining, with reference to cleaning frequencies thereof, specific areas that are to be cleaned simultaneously; and
interrupting the cleaning of the specific areas by a charging of an energy storage device of the robot such that, as far as possible, each of the specific areas is either completely cleaned or remains completely not cleaned during the charging.

19. The method according to claim 18, which comprises:
determining an amount of energy that is required in each case for cleaning the specific areas; and
planning the charging with reference to the determined amount of energy and a state of charge of the energy storage device of the robot.

20. The method according to claim 19, wherein the amount of energy comprises an energy that is required for a movement of the robot.

21. The method according to claim 19, which comprises cleaning the areas to which the same cleaning intensities are allocated as contiguously as possible.

22. The method according to claim 19, which comprises planning the charging such that a predetermined amount of energy is still present in the energy storage device at a start of a charging process.

23. The method according to claim 18, which comprises cleaning the areas to which the same cleaning intensities are allocated as contiguously as possible.

24. An apparatus for controlling a robot, the apparatus comprising:
a controller configured for moving the robot in a household and to perform a cleaning function;
wherein the household is divided into multiple areas;
wherein cleaning frequencies are allocated to the areas; and
the controller being configured to control a cleaning of each area in dependence upon the respective cleaning frequency that is allocated to the area.

25. A household robot, comprising an apparatus for controlling the robot according to claim 24.
